(19) United States
(12) Patent Application Publication
(10) Pub. No.: US 2026/0241640 A1
(43) Pub. Date: Aug. 20, 2026

(54) METHOD FOR MANUFACTURING ADDITIVELY FABRICATED OBJECT, ADDITIVELY FABRICATED OBJECT, AND MOVABLE JOINT

(71) Applicant: SHARP KABUSHIKI KAISHA, Osaka (JP)

(72) Inventor: HIROYUKI HIRAKAWA, Osaka (JP)

(21) Appl. No.: 19/532,858

(22) Filed: Feb. 6, 2026

(30) Foreign Application Priority Data
Feb. 18, 2025 (JP) 2025-024056

(51) Int. Cl. B29C 64/336; B29C 64/188; B33Y 10/00; B33Y 40/20; B33Y 80/00

(52) U.S. Cl. CPC B29C 64/336; B29C 64/188; B33Y 10/00; B33Y 40/20; B33Y 80/00

(57) ABSTRACT

A method for manufacturing an additively fabricated object, the method comprising using a three-dimensional fabrication apparatus of a fused deposition modeling type to fabricate an additively fabricated object in which a second fabricated object fabricated by a second resin incompatible with a first resin is stacked on a first fabricated object fabricated by the first resin, wherein one or more columnar structures penetrating inside of the first fabricated object are fabricated by the second resin incompatible with the first resin or a third resin compatible with the second resin in fabricating the first fabricated object.

### INCORPORATION BY REFERENCE

This application is based upon and claims the benefit of priority from the corresponding Japanese Patent Application No. 2025-024056 filed on Feb. 18, 2025, the entire contents of which are incorporated herein by reference.

The disclosure relates to a method for manufacturing an additively fabricated object using a three-dimensional fabrication apparatus of a fused deposition modeling type, an additively fabricated object, and a movable joint.

### Background Art

In recent years, fabrication of a structure by using a three-dimensional fabrication method has been performed, and fabrication using different types of resins may be performed.

However, in stacking a fabricated object of a different type of resin on a fabricated object of a lower layer, it is necessary that the resins forming the fabricated objects of the lower layer and the upper layer are compatible with each other, and if the resins are not compatible with each other, it is difficult to stack the resin on the fabricated object of the lower layer.

### SUMMARY

An object of the disclosure is to provide a novel method for manufacturing an additively fabricated object that enables stacking a fabricated object formed of a resin having no compatibility on a fabricated object of a lower layer, an additively fabricated object, and a movable joint.

A method for manufacturing an additively fabricated object according to an aspect of the disclosure is a method for manufacturing an additively fabricated object using a three-dimensional fabrication apparatus of a fused deposition modeling type, the method including a first fabrication step of fabricating a first fabricated object from a first resin on a fabrication bed or on a fabricated object of a lower layer, a columnar structure fabrication step of fabricating one or a plurality of columnar structures penetrating through an inside of the first fabricated object from a second resin incompatible with the first resin or a third resin compatible with the second resin at execution of the first fabrication step, and a second fabrication step of fabricating a second fabricated object joined to a first end portion of the columnar structure at a joint portion from the second resin on the first fabricated object fabricated by the execution of the first fabrication step.

In a method for manufacturing an additively fabricated object according to another aspect of the disclosure, it is preferable that, at execution of the columnar structure fabrication step, the columnar structure is fabricated such that a second end portion of the columnar structure on a side opposite to the first end portion is in contact with the fabrication bed or the fabricated object of a lower layer.

In a method for manufacturing an additively fabricated object according to another aspect of the disclosure, it is preferable that the columnar structure includes a base portion and a branch portion, and at execution of the columnar structure fabrication step, one or a plurality of the base portions are fabricated, and one or a plurality of the branch portions that branch from one of the base portions and are joined to the second fabricated object at the joint portion are fabricated.

In a method for manufacturing an additively fabricated object according to another aspect of the disclosure, it is preferable that, at execution of the second fabrication step, the joint portion is fabricated into a curved surface or a spherical surface.

In a method for manufacturing an additively fabricated object according to another aspect of the disclosure, it is preferable that, at execution of the columnar structure fabrication step, a plurality of the columnar structures are fabricated along a position that is an outer edge of the second fabricated object.

In a method for manufacturing an additively fabricated object according to another aspect of the disclosure, it is preferable that after the second fabrication step, a breaking step of breaking the columnar structure near the joint portion is executed.

An additively fabricated object according to another aspect of the disclosure includes a first fabricated object that is formed of a first resin as a material, one or a plurality of columnar structures that are formed of a second resin incompatible with the first resin or a third resin compatible with the second resin as a material and penetrate through inside of the first fabricated object, and a second fabricated object that is formed of the second resin as a material on the first fabricated object and is joined to a first end portion of the one or plurality of columnar structures at a joint portion.

In an additively fabricated object according to another aspect of the disclosure, it is preferable that, for one or a plurality of the columnar structures, a second end portion on a side opposite to the first end portion in the columnar structure penetrates the first fabricated object so as to reach a surface on a side opposite to a surface on which the second fabricated object is formed in the first fabricated object.

In an additively fabricated object according to another aspect of the disclosure, it is preferable that the columnar structure includes a base portion and a branch portion, and the branch portion branches from the one base portion into one or a plurality of the branch portions and is joined to the second fabricated object at the joint portion.

In an additively fabricated object according to another aspect of the disclosure, it is preferable that the joint portion has a curved surface shape or a spherical surface shape.

In an additively fabricated object according to another aspect of the disclosure, it is preferable that the additively fabricated object includes a plurality of the columnar structures disposed along an outer edge of the second fabricated object.

In an additively fabricated object according to another aspect of the disclosure, it is preferable that the columnar structure is broken near the joint portion.

In an additively fabricated object according to another aspect of the disclosure, it is preferable that the first fabricated object and the second fabricated object are relatively slidable or rotatable in a state where surfaces thereof are in contact with each other.

A movable joint of the disclosure for solving the technical problem according to another aspect of the disclosure includes the additively fabricated object.

According to the disclosure, it is possible to stack a fabricated object fabricated from a resin having no compatibility on a fabricated object of a lower layer.

This Summary is provided to introduce a selection of concepts in a simplified form that are further described below in the Detailed Description with reference where appropriate to the accompanying drawings. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a perspective view of an additively fabricated object according to a first embodiment in a transparent state.

FIG. 2 is a cross-sectional view of the additively fabricated object.

FIG. 3 is a perspective view showing a state in which columnar structures of the additively fabricated object are broken.

FIG. 4 is a perspective view showing a state in which the additively fabricated object is manufactured using a three-dimensional fabrication apparatus.

FIG. 5 is a perspective view showing a state in which a first fabricated object manufacturing step and a columnar structure fabrication step are being performed using the three-dimensional fabrication apparatus, in a partially transparent state.

FIG. 6 is a perspective view showing a state in which a second fabricated object manufacturing step is being performed using the three-dimensional fabrication apparatus in a partially transparent state.

FIG. 7 is a cross-sectional view showing another embodiment (three-tier structure) of the additively fabricated object.

FIG. 8 is a perspective view showing the additively fabricated object constructed as a movable joint (cylinder joint) in a transparent state.

FIG. 9 is a cross-sectional view of the additively fabricated object.

FIG. 10 is a perspective view showing the additively fabricated object constructed as a movable joint (ball joint) in a transparent state.

### BRIEF DESCRIPTION OF THE DRAWINGS

Hereinafter, embodiments of the disclosure will be described with reference to the accompanying drawings for an understanding of the disclosure. Note that the following embodiments are specific examples of the disclosure, and do not limit the technical scope of the disclosure.

### First Embodiment

### Additively Fabricated Object 1

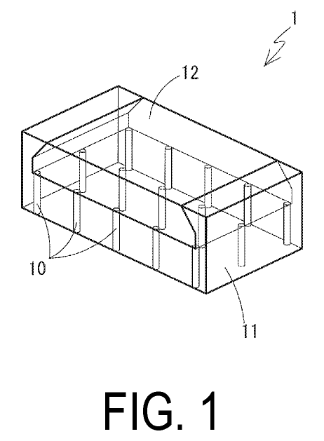

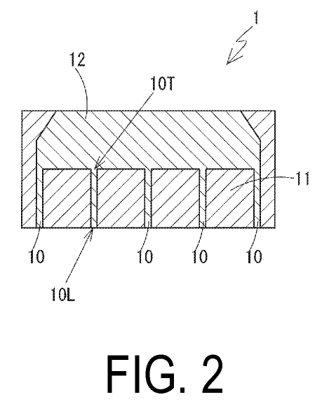

FIG. 1 is a perspective view showing an additively fabricated object 1 of the disclosure according to a first embodiment, and FIG. 2 is a cross-sectional view of the additively fabricated object 1. The additively fabricated object 1 includes a "first fabricated object 11", a "second fabricated object 12" formed on the first fabricated object 11, and one or a plurality of "columnar structures 10" penetrating the inside of the first fabricated object 11.

### First Fabricated Object 11, Second Fabricated Object 12

The first fabricated object 11 is formed of a first resin as a material. On the other hand, the second fabricated object 12 is formed of a second resin that is not compatible with the first resin.

### Columnar Structure 10

The columnar structure 10 is formed of the second resin as a material. A first end portion (upper end portion) 10T of the columnar structure 10 is joined to the second fabricated object 12 at a joint portion (interface between the first fabricated object 11 and the second fabricated object 12) between the first fabricated object 11 and the second fabricated object 12 (see FIG. 2). On the other hand, a second end portion (lower end portion) 10L of the columnar structure 10 reaches the surface (lower surface of the first fabricated object 11) of the first fabricated object 11 opposite to the surface on which the second fabricated object 12 is formed (see FIG. 2).

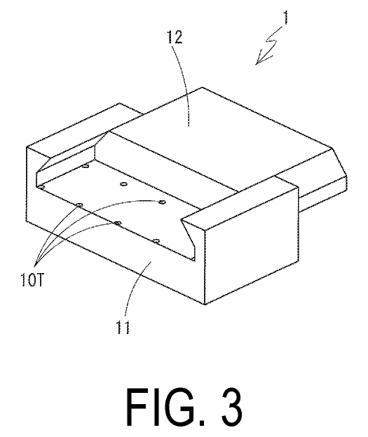

The additively fabricated object 1 according to the present embodiment has a mechanism capable of breaking the columnar structure 10 in the vicinity of the joint portion. FIG. 3 shows the additively fabricated object 1 after breakage of the columnar structure 10. In the additively fabricated object 1 after breakage of the columnar structure 10, the first fabricated object 11 and the second fabricated object 12 are relatively slidable in a state of being in surface contact with each other.

### Method for Manufacturing Additively Fabricated Object 1

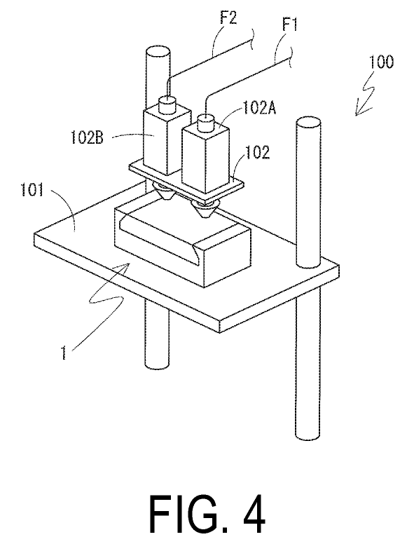

FIG. 4 shows a state of manufacturing the additively fabricated object 1. The additively fabricated object 1 is manufactured by the method for manufacturing the additively fabricated object 1 of the disclosure. In the manufacturing method, the additively fabricated object 1 is manufactured by using a "three-dimensional fabrication apparatus 100" of a fused deposition modeling type, and a "first fabrication step" of fabricating the first fabricated object 11, a "columnar structure fabrication step" of fabricating the columnar structure 10, and a "second fabrication step" of fabricating the second fabricated object 12 are executed.

### Three-Dimensional Fabrication Apparatus 100

The three-dimensional fabrication apparatus 100 includes a "fabrication bed 101" and an "extrusion head 102" as main components.

### Fabrication Bed 101

The fabrication bed 101 is a base on which an object to be fabricated is to be placed, and is movable in the vertical direction in the drawing.

### Extrusion Head 102

The extrusion head 102 includes two nozzles (102A and 102B). A filament F1 of the first resin is supplied to one nozzle 102A, and a filament F2 of the second resin is supplied to the other nozzle 102B. The nozzles ((102A and 102B) melt the filaments (F1 and F2) sequentially supplied and inject the molten resins onto the fabrication bed in such a manner as to extrude the molten resins. The extrusion head 102 is movable in a horizontal plane in the drawing, and can draw a resin layer of an arbitrary pattern on the fabrication bed 101 by injecting a resin from the nozzles (102A and 102B) at a predetermined timing while moving the extrusion head 102. After the resin layer is drawn on the fabrication bed 101, the fabrication bed 101 is processed, and a pattern of a new resin layer is further stacked thereon to obtain a three-dimensional fabricated object.

### First Fabrication Step, Columnar Structure Fabrication Step

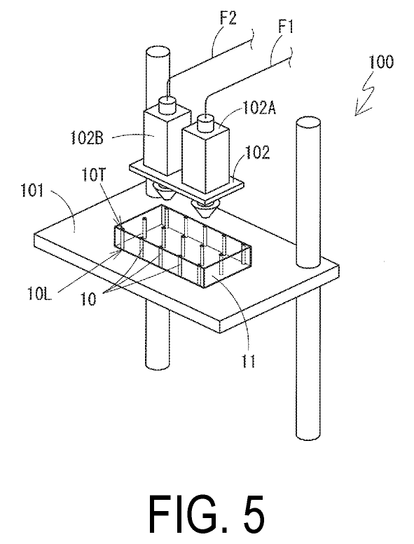

FIG. 5 shows a state in which the first fabricated object fabrication step and the columnar structure fabrication step are performed using the three-dimensional fabrication apparatus 100. In the first fabrication step, the first fabricated object 11 is fabricated from the first resin on the fabrication bed 101. On the other hand, in the columnar structure fabrication step, one or a plurality of columnar structures 10 penetrating the inside of the first fabricated object 11 are fabricated from the second resin at the time of executing the first fabrication step.

That is, the first fabrication step and the columnar structure fabrication step are performed simultaneously. In the present embodiment, the first fabrication step and the columnar structure fabrication step are performed by repeating an operation of drawing a dot pattern by injecting the second resin from the nozzle 102B to which the filament F2 of the second resin is supplied to a plurality of positions to be the columnar structures 10, and drawing a pattern of the first fabricated object 11 by the nozzle 102A to which the filament F1 of the first resin is supplied so as to fill the periphery of the dot pattern.

In the present embodiment, the plurality of columnar structures 10 are formed along the outer edge of the second fabricated object 12 at the time of execution of the columnar structure fabrication step.

The first fabricated object 11 is fabricated on the fabrication bed 101 by executing each step. The first fabricated object 11 is provided with the plurality of columnar structures 10 penetrating the inside. The first end portion (upper end portion) 10T of the columnar structure 10 is exposed on the upper surface of the first fabricated object 11. On the other hand, the second end portion (lower end portion) 10L of the columnar structure 10 is in contact with the fabrication bed 101.

### Second Fabrication Step

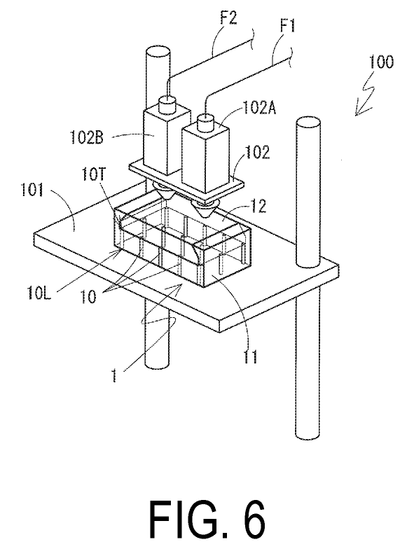

FIG. 6 shows a state in which the second fabricated object fabrication step is performed using the three-dimensional fabrication apparatus 100. In the second fabrication step, the second fabricated object 12 is fabricated from the second resin on the first fabricated object 11 fabricated by the execution of the first fabrication step.

In the present embodiment, the second fabrication step is performed by repeating an operation of drawing the pattern of the second fabricated object 12 by the nozzle 102B to which the filament F2 of the second resin is supplied.

Since the first resin and the second resin are not compatible with each other, it is impossible in principle to fabricate the second fabricated object 12 from the second resin on the first fabricated object 11 fabricated from the first resin.

In this regard, in the disclosure, when the columnar structure fabrication step is executed, the plurality of columnar structures 10 are provided in the first fabricated object 11, and the first end portions (upper end portions) 10T of the columnar structures 10 are exposed on the upper surface of the first fabricated object 11. Therefore, at the time of execution of the second fabrication step, the first end portions (upper end portions) 10T of the columnar structures 10 function as joint bases with the second resin, and as a result, the second fabricated object 12 can be fabricated on the first fabricated object 11 in a state of being joined to the first end portions 10T of the columnar structures 10.

In addition, the columnar structures 10 are fabricated along the outer edge, thereby preventing peeling-off of the outer edge portion of the second fabricated object 12 and achieving precise fabrication of the edge portion.

According to the disclosure, it is possible to stack a fabricated object fabricated from a resin having no compatibility on a fabricated object of a lower layer.

In the present embodiment, the additively fabricated object 1 is configured to exhibit a sliding function by breaking the columnar structures 10, but the configuration of the additively fabricated object 1 is not particularly limited. The additively fabricated object 1 is not necessarily limited to the one that is premised on the breaking of the columnar structures 10.

In the present embodiment, each columnar structure 10 has the first end portion (upper end portion) 10T joined to the second fabricated object 12, and a second end portion (lower end portion) 10L reaching the lower surface of the first fabricated object 11.

However, the second end portion (lower end portion) 10L may not reach the lower surface of the first fabricated object 11.

In addition, in the present embodiment, the columnar structures 10 are formed using the second resin as a material. However, instead of the second resin, a third resin compatible with the second resin may be used as a material for forming the columnar structures 10. For example, if the second resin is an expensive material, the columnar structures 10 can be formed of the inexpensive third resin to achieve cost reduction.

In the present embodiment, at the time of execution of the columnar structure fabrication step, the plurality of columnar structures 10 are formed along the outer edge of the second fabricated object 12. However, the number and arrangement of the columnar structures 10 are not particularly limited. Nevertheless, it has been confirmed that the second fabricated object 12 is fabricated more stably as the number of the columnar structures 10 is increased, and that the edge portion of the second fabricated object 12 is fabricated more precisely as the plurality of columnar structures 10 are arranged along the outer edge of the second fabricated object 12.

On the other hand, when the number of the columnar structures 10 is increased or the cross-sectional area of each columnar structure 10 (particularly, the cross-sectional area of the first end portion (upper end portion) 10T) is increased, the physical properties of the first fabricated object 11 may be changed or the columnar structures 10 may become difficult to break.

Therefore, in the disclosure, the volume of the columnar structures 10 in the first fabricated object 11 is preferably 10% or more (more preferably in the range of 15 to 30%) of the volume of the first fabricated object 11 in order to maintain the physical properties of the first fabricated object 11. The cross-sectional area of the columnar structure 10 (particularly, the cross-sectional area of the first end portion (upper end portion) 10T) is preferably 1.54 mm2 (diameter 1.4 mm) or less (more preferably 1.13 mm2 (diameter 1.2 mm) to 0. 50 mm2 (diameter 0.8 mm).

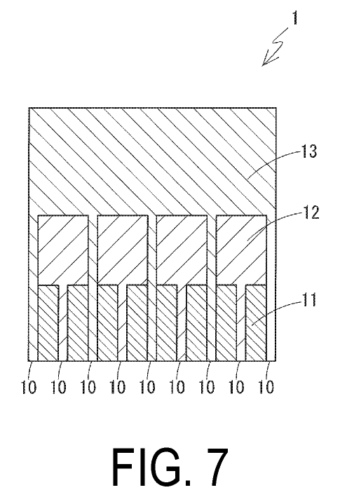

Further, in the present embodiment, the additively fabricated object 1 has a two-layer structure of the first fabricated object 11 and the second fabricated object 12. However, another fabricated object to be a lower layer of the first fabricated object 11 may be fabricated before fabrication of the first fabricated object 11, or another fabricated object (third fabricated object 13) may be fabricated on an upper layer of the second fabricated object 12 as in the additively fabricated object 1 having a three layer structure shown in FIG. 7. In this case, if the resin for forming the third fabricated object 13 is not compatible with the second resin, it is preferable to construct the columnar structures 10 penetrating the second fabricated object 12 (in some cases, both the first fabricated object 11 and the second fabricated object 12) from the resin.

### Second Embodiment

### Additively Fabricated Object 1

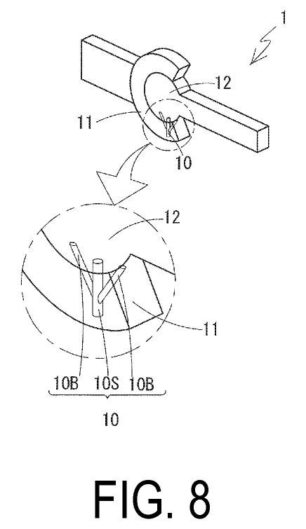

FIG. 8 is a perspective view illustrating an additively fabricated object 1 of the present disclosure according to a second embodiment. The additively fabricated object 1 includes a "first fabricated object 11", a "second fabricated object 12" formed on the first fabricated object 11, and a "columnar structure 10" penetrating the inside of the first fabricated object 11.

### First Fabricated Object 11, Second Fabricated Object 12

The first fabricated object 11 is formed of a first resin as a material. On the other hand, the second fabricated object 12 is formed of a second resin that is not compatible with the first resin.

### Columnar Structure 10

The columnar structure 10 is formed of the second resin as a material. In the present embodiment, the columnar structure 10 includes a base portion 10S and a branch portion 10B. The branch portion 10B branches off from the base portion 10S to one or a plurality of the branch portions 10B and is joined to the second fabricated object 12 at a joint portion that is an interface between the first fabricated object 11 and the second fabricated object 12.

The additively fabricated object 1 is provided in the form of a movable joint (cylinder joint). When the columnar structure 10 is broken near the joint portion, the first fabricated object 11 and the second fabricated object 12 can slide relative to each other in a state where the surfaces thereof are in contact with each other.

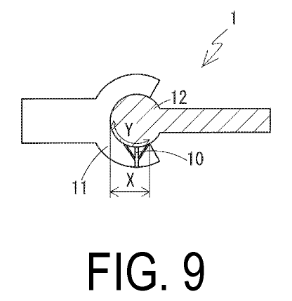

FIG. 9 is a cross-sectional view of the additively fabricated object 1. The additively fabricated object 1 in the form of a movable joint (cylinder joint) has a curved surface at the joint portion. Therefore, a projected area (X) of the joint portion in the downward direction is smaller than an area (Y) of the joint portion, and it may be difficult to secure a space for arranging a sufficient number of the columnar structures 10.

In this regard, in the present embodiment, the columnar structure 10 is formed such that the branch portion 10B branches from the base portion 10S, whereby a sufficient number of joint sites can be secured in the joint portion.

The rest is the same as the first embodiment, and the description thereof is omitted here to avoid repetition.

### Third Embodiment

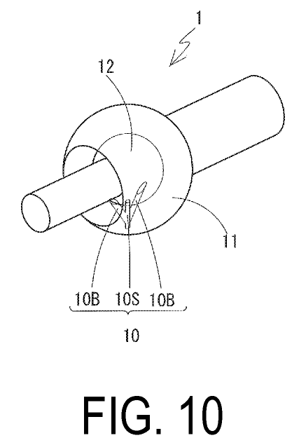

FIG. 10 is a perspective view illustrating an additively fabricated object 1 of the present disclosure according to a third embodiment. The additively fabricated object 1 is provided in the form of a movable joint (ball joint). When the columnar structure 10 is broken near the joint portion, the first fabricated object 11 and the second fabricated object 12 are relatively slidable in a state where the surfaces thereof are in contact with each other.

In the additively fabricated object 1 in the form of a movable joint (ball joint), since the joint portion has a spherical surface, it may be difficult to secure a space for arranging a sufficient number of the columnar structures 10 as in the second embodiment.

In this regard, in the present embodiment, the columnar structure 10 is formed such that the branch portion 10B branches from the base portion 10S, whereby a sufficient number of joint sites can be secured in the joint portion.

The rest is the same as the first and second embodiments, and the description thereof is omitted here to avoid repetition.

It is to be understood that the embodiments herein are illustrative and not restrictive, since the scope of the disclosure is defined by the appended claims rather than by the description preceding them, and all changes that fall within metes and bounds of the claims, or equivalence of such metes and bounds thereof are therefore intended to be embraced by the claims.

1. A method for manufacturing an additively fabricated object using a three-dimensional fabrication apparatus of a fused deposition modeling type, the method comprising:
a first fabrication step of fabricating a first fabricated object from a first resin on a fabrication bed or on a fabricated object of a lower layer;
a columnar structure fabrication step of fabricating one or a plurality of columnar structures penetrating through an inside of the first fabricated object from a second resin incompatible with the first resin or a third resin compatible with the second resin at execution of the first fabrication step; and
a second fabrication step of fabricating a second fabricated object joined to a first end portion of the columnar structure at a joint portion from the second resin on the first fabricated object fabricated by the execution of the first fabrication step.

2. The method for manufacturing an additively fabricated object according to claim 1, wherein in the columnar structure fabrication step, the columnar structure is fabricated such that a second end portion on a side opposite to the first end portion of the columnar structure is in contact with the fabrication bed or the fabricated object of the lower layer.

3. The method for manufacturing an additively fabricated object according to claim 1, wherein
the columnar structure includes a base portion and a branch portion, and
in the columnar structure fabrication step, one or a plurality of the base portions are fabricated, and one or a plurality of the branch portions that branch from one of the base portions and are joined to the second fabricated object at the joint portion are fabricated.

4. The method for manufacturing an additively fabricated object according to claim 3, wherein in the second fabrication step, the joint portion is fabricated in a shape with a curved surface or a spherical surface.

5. The method for manufacturing an additively fabricated object according to claim 1, wherein in the columnar structure fabrication step, a plurality of the columnar structures are fabricated along an outer edge of the second fabricated object.

6. The method for manufacturing an additively fabricated object according to claim 1, further comprising a breaking step of breaking the columnar structure near the joint portion after the second fabrication step.

7. An additively fabricated object comprising:
a first fabricated object that is formed of a first resin as a material;
one or a plurality of columnar structures that are formed of a second resin incompatible with the first resin or a third resin compatible with the second resin as a material and penetrate through inside of the first fabricated object; and
a second fabricated object that is formed of the second resin as a material on the first fabricated object and is joined to a first end portion of the one or plurality of columnar structures at a joint portion.

8. The additively fabricated object according to claim 7, wherein the one or plurality of columnar structures penetrate the first fabricated object such that a second end portion of the columnar structure on a side opposite to the first end portion reaches a surface of the first fabricated object on a side opposite to a surface on which the second fabricated object is formed.

9. The additively fabricated object according to claim 7, wherein
the columnar structure includes a base portion and a branch portion, and
the branch portion branches from one of the base portions into one or a plurality of the branch portions, and is joined to the second fabricated object at the joint portion.

10. The additively fabricated object according to claim 9, wherein the joint portion has a shape with a curved surface or a spherical surface.

11. The additively fabricated object according to claim 7, wherein a plurality of the columnar structures are arranged along an outer edge of the second fabricated object.

12. The additively fabricated object according to claim 7, wherein the columnar structure is broken near the joint portion.

13. The additively fabricated object according to claim 12, wherein the first fabricated object and the second fabricated object are relatively slidable or rotatable in a state where surfaces of the first fabricated object and the second fabricated object are in contact with each other.

14. A movable joint comprising the additively fabricated object according to claim 12.
